(19) United States
(12) Patent Application Publication
(10) Pub. No.: US 2023/0315286 A1
(43) Pub. Date: Oct. 5, 2023

(54) STORAGE SYSTEM AND CONTROL METHOD FOR STORAGE SYSTEM

(71) Applicant: Hitachi, Ltd., Tokyo (JP)

(72) Inventors: Hiroto EBARA, Tokyo (JP); Hideo SAITO, Tokyo (JP); Takaki NAKAMURA, Tokyo (JP); Misato YOSHIDA, Tokyo (JP); Naruki KURATA, Tokyo (JP); Takahiro YAMAMOTO, Tokyo (JP)

(73) Assignee: Hitachi, Ltd., Tokyo (JP)

(21) Appl. No.: 17/943,845

(22) Filed: Sep. 13, 2022

(30) Foreign Application Priority Data
Mar. 31, 2022 (JP) 2022-060663

(51) Int. Cl. G06F 3/06

(52) U.S. Cl. CPC G06F 3/0604; G06F 3/067; G06F 3/0632; G06F 3/0664

(57) ABSTRACT

Provided is a processor configured to cause each of a plurality of servers to operate a storage node, configured to combine a plurality of the storage nodes to set a storage cluster, configured to perform a comparison between a maintenance plan for the storage cluster and a state of the storage cluster to modify the maintenance plan based on a result of the comparison, and configured to perform maintenance for the storage cluster in accordance with the maintenance plan modified.

### BACKGROUND OF THE INVENTION

### 1. Field of the Invention

The present invention relates to a storage system and a control method for the storage system, and particularly to a scale-out storage system.

### 2. Description of the Related Art

Conventionally, there is known a system where storage nodes loaded in a plurality of servers are combined to form a storage cluster, and the storage cluster is arranged across the plurality of servers. In the system, redundancy is implemented among a plurality of the storage nodes included in the storage cluster, so that the plurality of storage nodes are scaled out in the storage cluster and a user's access to the storage cluster is more available and reliable.

As a scale-out storage system of this type, for example, US 2019/0163593 A discloses a system where a plurality of computer nodes, each having a storage device, are interconnected via a network.

### SUMMARY OF THE INVENTION

The storage cluster described above is implemented in a cloud system. An operating entity of the cloud system performs, for maintenance of hardware and software, closure of each of the storage nodes for maintenance, and subsequently performs recovery of the corresponding storage node from the closure for the maintenance.

Among the cloud systems, unlike an on-premise cloud, an operating entity of a public cloud plans maintenance for convenience of the operating entity. In response to this, a user of the public cloud is allowed to request a host service of the public cloud for change of the maintenance plan.

However, in a situation where the storage cluster includes a large number of scaled-out storage nodes and servers, arrangements between the host service and the user in the public cloud is not smoothly carried out, which may undermine stable management of the storage cluster, such as the user of the public cloud unexpectedly undergoes the closure of the storage nodes for maintenance, leading to degraded level of redundancy and then to a stoppage of input/output (I/O) from a client of the user. In view of the respects described above, an object of the present invention is to provide a storage system configured to achieve maintenance in accordance with a maintenance plan for a storage cluster, the maintenance leading to stable management of the storage cluster.

In order to achieve the object, the present invention provides a storage system and a control method for the storage system. The storage system includes a plurality of servers connected to one another via a network, and a storage device. Each of the plurality of servers includes a processor configured to process data input to and output from the storage device, and a memory. In the storage system, the processor causes each of the plurality of servers to operate a storage node, combines a plurality of the storage nodes to set a storage cluster, performs a comparison between a maintenance plan for the storage cluster and a state of the storage cluster, so as to modify the maintenance plan based on a result of the comparison, and performs maintenance for the storage cluster in accordance with the maintenance plan modified.

The present invention can provide a storage system configured to achieve maintenance in accordance with a maintenance plan for a storage cluster, the maintenance leading to stable management of the storage cluster.

### BRIEF DESCRIPTION OF THE DRAWINGS

FIG. 1 is a block diagram of a hardware of a storage system according to an embodiment of the present invention;

FIG. 2 is a block diagram of a hardware of each of a server and a shared storage system;

FIG. 3 is a functional block diagram of a relationship between a storage node and a volume;

FIG. 4 is a functional block diagram of an example of a logic configuration of the storage system;

FIG. 5 is a block diagram of an example of a configuration of a memory included in the server that operates the storage node;

FIG. 6 illustrates a block diagram of details of metadata of each table stored in the memory of the server;

FIG. 7 illustrates a block diagram of details of metadata of each of the other tables;

FIG. 8 illustrates a block diagram of details of metadata of each of the other tables;

FIG. 9 is a flowchart of a method where a storage cluster administrator system registers storage node maintenance plan information for the storage cluster;

FIG. 10 is a flowchart of a storage node maintenance plan information update processing program;

FIG. 11 is a flowchart of a storage node maintenance processing program;

FIG. 12 is a flowchart of details of a storage node maintenance closure processing program; and

FIG. 13 is a flowchart of details of a storage node maintenance recovery processing program.

### DESCRIPTION OF THE PREFERRED EMBODIMENTS

An embodiment of the present invention will be described in detail below with reference to the appended drawings. Descriptions below and the appended drawings are merely illustrative for convenience of describing the present invention, and are omitted or simplified as appropriate for clarification of the description. Additionally, not all combinations of elements described in the embodiment are essential to the solution of the invention. The present invention is not limited to the embodiment, and various modifications and changes appropriately made within techniques of the present invention will naturally fall within the scope of claims of the present invention. Thus, it is easily understood for those skilled in the art that any change, addition, or deletion of a configuration of each element may appropriately be made within the spirit of the present invention. The present invention may be implemented in other various manners. Unless otherwise limited, each component may be singular or plural.

In the descriptions below, various types of information may be referred to with expressions such as “table”, “chart”, “list”, and “queue”, but in addition to these, the various types of information may be expressed with other data structures. Additionally, expressions such as “XX table”, “XX list”, and others may be referred to as “XX information” to indicate that the present invention is not limited to any one of the data structures. In describing the content of each piece of information, expressions such as “identification information”, “identifier”, “name”, “ID”, and “number” are used, and these may be replaced with one another.

In the descriptions below, when identical or equivalent elements are described without being distinguished, reference signs or common numbers in the reference signs may be used; and when the identical or equivalent elements are described as distinguished from the others, other reference signs may be used, or instead of the other reference signs, IDs may be allocated to the identical or equivalent elements distinguished.

Further, in the descriptions below, processing may be performed by executing a program, hut the program is executed by at least one or more processor(s) (e.g., a central processing unit (CPU)) such that predetermined processing is performed with use of a storage resource (e.g., a memory) and/or an interface device (e.g., a communication port) as appropriate. Therefore, the subject of the processing may be the processor. Similarly, the subject of the processing performed by executing the program may be a controller, a device, a system, a computer, a node, a storage system, a storage device, a server, a management computer, a client, or a host, in which the processor is included. The subject (e.g., the processor) of the processing performed by executing the program may include, for example, a hardware circuit that partially or entirely performs the processing. For example, the subject of the processing performed by executing the program may include a hardware circuit that performs encryption/decryption or compression/decompression. The processor operates in accordance with the program, so as to serve as a functional unit to achieve predetermined functions. Each of the device and the system, in which the processor is included, includes the functional unit.

The program may be installed from a program source into a device such as a computer. The program source may be, for example, a program distribution server or a computer-readable storage medium. When the program source is the program distribution server, the program distribution server may include the processor. (e.g., the CPU) and the storage resource, and the storage resource may further store a distribution program and a program to be distributed. Then, the processor included in the program distribution server may execute the distribution program, so as to distribute the program to be distributed to other computers. In the descriptions below, two or more programs may be implemented as one program, or one program may be implemented as two or more programs.

In the descriptions below, the “processor” may be one or more processor device(s). At least one of the processor devices may typically be a microprocessor device such as the central processing unit (CPU), or alternatively, may be other types of processor devices such as a graphics processing unit (GPU). The at least one of the processor devices may be a single core or a multi-core processor. The at least one of the processor devices may be a processor core. The at least one of the processor devices is used to partially or entirely perform the processing, and may be a processor device such as an integrated gate array circuit in a hardware description language (for example, a field-programmable gate array (FPGA) or a complex programmable logic device (CPLD)) or may be a widely known processor device such as an application specific integrated circuit (ASIC).

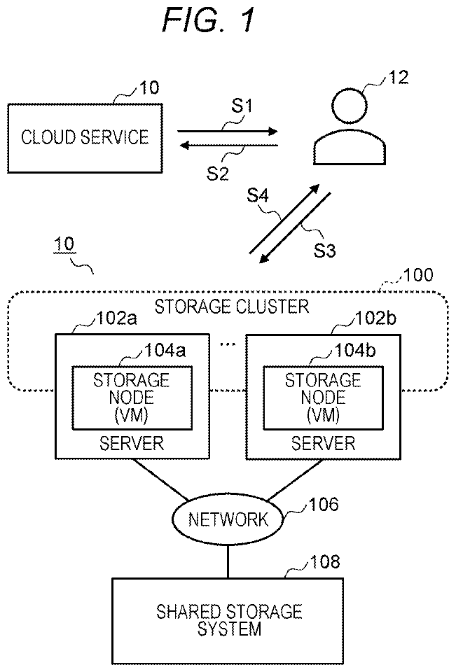

Next, an embodiment of a storage system according to the present invention will be described with reference to the appended drawings. FIG. 1 is a block diagram of a hardware of the storage system according to the embodiment of the present invention. The storage system includes, for example, a public cloud system 10 as a cloud system, and may further include a storage cluster administrator system 12 of a storage cluster 100 in the public cloud system 10.

The public cloud system 10 includes a plurality of servers 102, i.e., a server 102a, a server 102b, . . . . In each of the plurality of servers, a corresponding one of virtual machines (VM) 104, i.e., a virtual machine (VM) 104a, a virtual machine (VM) 104b, . . . , is loaded. Each of the virtual machines 104 has a control software loaded therein, so that the corresponding virtual machine 104 functions as a storage node, in other words, a storage controller. The control software may be, for example, a software defined storage (SDS) or a software-defined datacenter. (SDDC) such that the VM is configured as a software-defined anything (SDx).

Each of the storage nodes (VMs) 104a, 104b, provides a storage area for reading or writing data from or to a compute node, in other words, a host device such as a host of a user. Each of the storage nodes may be a hardware of the corresponding server.

In the public cloud system 10, a plurality of the storage nodes 104 are combined by the control software, so that the storage cluster 100 is scalable across the plurality of servers. FIG. 1 illustrates, as an example, the storage system where the storage cluster 100 is set as only a single storage cluster, but the storage system may include a plurality of the storage clusters. The storage cluster 100 concurrently corresponds to a distributed storage system.

Each of the plurality of servers 102 is connected to a shared storage system 108 via a network 106. The shared storage system 108 is shared by the plurality of servers 102, and provides a storage area of a storage device of the shared storage system 108 to each of the plurality of storage nodes 104.

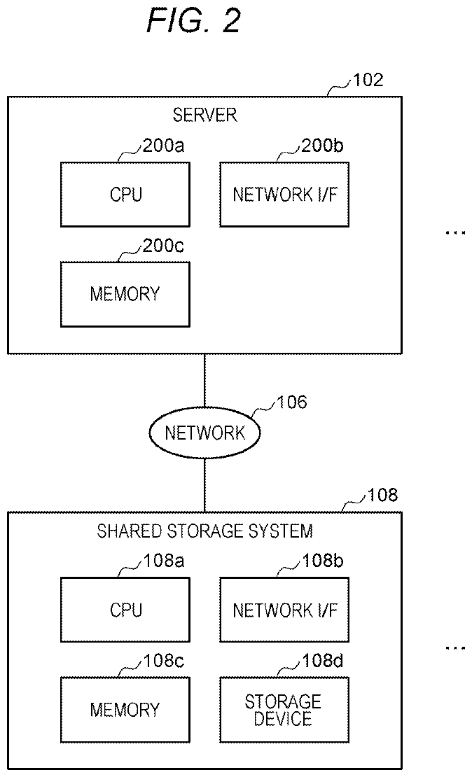

FIG. 2 illustrates an example of a block diagram of a hardware of each of the plurality of servers and a block diagram of a hardware of the shared storage system. As illustrated in FIG. 2, each of the plurality of servers 102 includes a CPU 200a, a memory 200c, and a network I/F 200b, which are physically connected to one another via a bus. The CPU 200a is a processor configured to control an operation of each of the plurality of storage nodes 104 (VM 104) as a whole. The memory 200c includes a volatile semiconductor memory such as a static random access memory (SRAM) or a dynamic random access memory (DRAM), or a nonvolatile semiconductor memory, and is used as a work memory of the CPU 200a to temporarily hold various programs and required data.

When the CPU 200 executes the program stored in the memory 200c, various types of processing is executed for each of the plurality of storage nodes 104 as the whole, as will be described later. The network I/F 200b is configured to connect each of the plurality of servers 102 with the network 106 and is, for example, an Ethernet network interface card (NIC) (Ethernet as a registered trademark). The CPU 200 is an example of the controller or the processor.

The shared storage system includes a CPU 108a, a network I/F 108b, a memory 108c, and a storage device 108d, which are physically connected to another via the bus. The storage device 108d includes a large-capacity nonvolatile storage device such as a hard disk drive (HDD), a solid state drive (SSD), or a storage class memory (SCM), and provides the storage area for reading or writing of the data in response to a read request or a write request from each of the plurality of storage nodes 104. The network 106 is one or more device(s) configured to physically interconnect each of the plurality of storage nodes 104 and the shared storage system 108, and is, for example, a network switch such as the Ethernet.

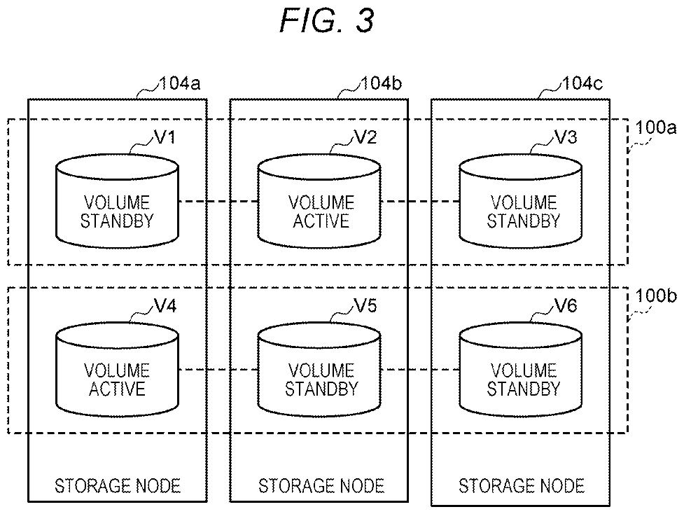

FIG. 3 is a functional block diagram of a relationship between each of the plurality of storage nodes and a corresponding one of volumes V. As illustrated in FIG. 3, a control program, which is previously described as the control software loaded in each of the plurality of storage nodes 104 of the storage cluster 100, provides from the storage cluster 100 to each application a volume V1, a volume V2, a volume V3, a volume V4, a volume V5, or a volume V6 as an example to access the reading or the writing of the data. Here, in order to secure redundancy of the data, each of redundancy groups 100a and 100b is set across a plurality of the volumes. FIG. 3 illustrates the redundancy groups 100a and 100b as two redundancy groups arranged across the storage nodes 104a, 104b, and 104c. The redundancy group 100a includes the volumes V1, V2, and V3 as a redundant pair; and the volume V2 functions as an active volume, and the other volumes V1 and V3 function as standby volumes.

The redundancy group 100b includes the volumes V4, V5, and V6 as the redundant pair; and the volume V4 functions as the active volume, and the other volumes V5 and V6 function as the standby volumes. The storage device 108d of the shared storage system 108 may allocate to each of the volumes a physical storage area for the reading or writing of the data based on, for example, thin provisioning technology. Accordingly, each of the volumes may be a virtual volume. Note that, FIG. 3 illustrates each of the redundancy groups including three of the volumes, but may alternatively include four or more volumes.

As illustrated in FIG. 3, the storage node 104a has ownership of the volumes V1 and V4, the storage node 104b has the ownership of the volumes V2 and V5, and the storage node 104c has the ownership of the volumes V3 and V6.

“Volume active” indicates a state (active mode) where the corresponding volume is set to accept the read request and the write request, while “volume standby” indicates a state (passive mode) where the corresponding volume is set not to accept the read request or the write request. The state of each of the volumes is managed by a table as will be described later.

When each of the volumes that has been set in the active mode is closed for maintenance, any one of the other volumes in the redundant pair (where the corresponding volume is included) is switched from the standby mode into the active mode. With this configuration, even when the volume that has been set in the active mode is inoperable, any one of the other volumes switched into the active mode can take over input/output (I/O) processing that the corresponding volume has executed (fail-over processing).

Subsequently, when having been recovered from the closure for maintenance, the corresponding volume is to take over the I/O processing executed by any one of the other volumes that has been 1:3 switched from the standby mode into the active mode (fail-back processing). Note that, a difference in data during the fail-over processing, in other words, the data (difference data) written in during the fail-over processing is to be reflected in the corresponding volume after taking over the I/O processing in the fail-back processing (rebuild processing).

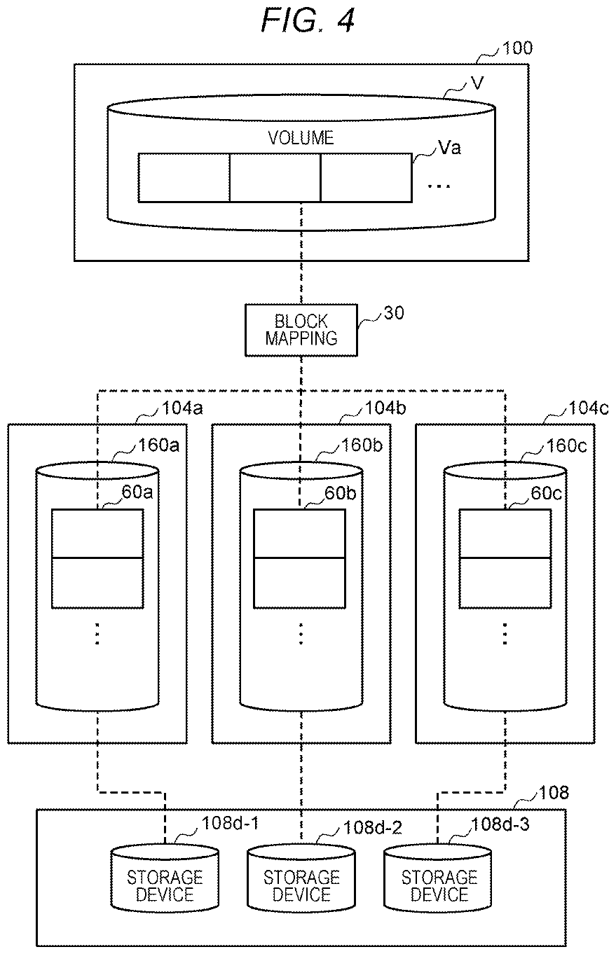

FIG. 4 is a diagram illustrating an example of a logic configuration of the storage system. The shared storage system 108 includes the storage devices 108d, i.e., storage devices 108d-1, 108d-2, and 108d-3, which are respectively in correspondence to logic devices 160a, 160b, and 160c included in the storage nodes 104a, 104b, and 104c. Each of the volumes V described previously includes a page Va in the storage cluster 100, and the control program includes a mapping module 30. Here, the pages Va are respectively allocated by the mapping module 30 to pages 60a, 60b, and 60c of the logic devices 160a, 160b, and 160c (block mapping). The pages 60a, 60b, and 60c form a parity group.

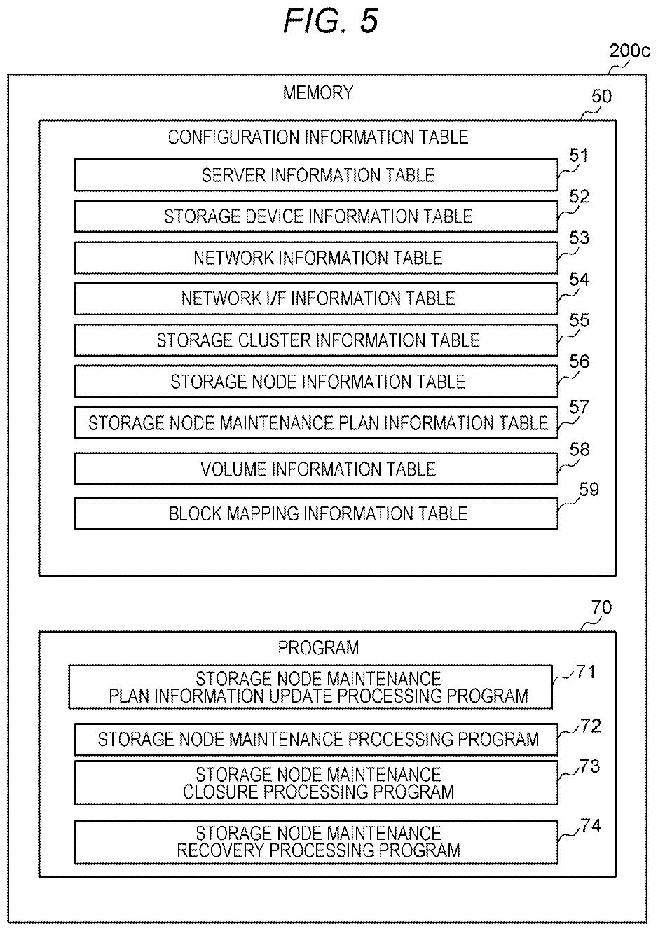

FIG. 5 is a diagram of an example of a configuration of the memory 200c included in each of the plurality of servers 102 that operates the corresponding storage node 104 (VM 104). The memory 200c includes a configuration information table area 50 and a program area 70. The configuration information table area 50 includes, for example, a server information table 51, a storage device information table 52, a network information table 53, a network I/F information table 54, a storage cluster information table 55, a storage node information table 56, a storage node maintenance plan information table 57, a volume information table 58, and a block mapping information table 59.

The program area 70 includes a storage node maintenance plan information update processing program 71, a storage node maintenance processing program 72, a storage node maintenance closure processing program 73, and a storage node maintenance recovery processing program 74.

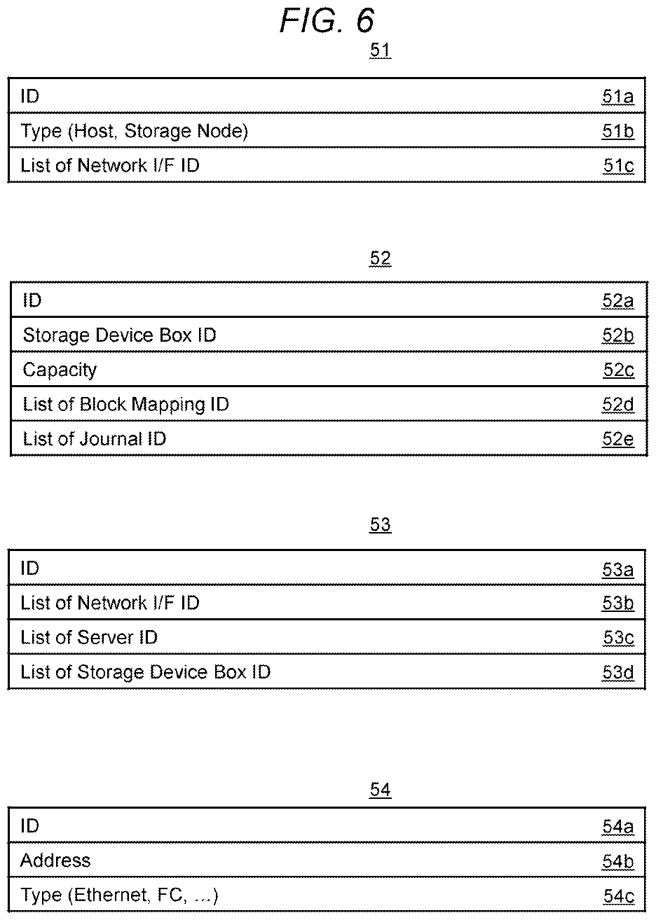

Details of metadata of each of the tables above will be described with reference to FIG. 6. The server information table 51 includes information for each of the plurality of servers 102, and an ID (51a) corresponds to a value (e.g., a universally unique identifier (QUID)) that uniquely specifies the corresponding server 102. Here, a type (host, storage node) (51b) corresponds to information that distinguishes whether the corresponding server 102 is a server or a storage node. A list of network I/F ID (51c) corresponds to a list of IDs of network I/F information loaded in the server.

The storage device information table 52 includes information for each of the storage devices 108d of the shared storage system 108, and includes, for example, a storage device 1D (52a), a storage device box ID (52b) as an ID of a device box where the corresponding storage device is loaded, a capacity (52c) as a maximum capacity of the corresponding storage device, a list of block mapping ID (52d) as a list of IDs of the block mapping information allocated to the corresponding storage device, and a list of journal ID (52e) as an ID of journal information allocated to the corresponding storage device.

The network information table 53 includes information for each of the networks, and includes, for example, an ID (53a) of the corresponding network, a list of network I/F ID (53b) as a list of IDs of the network I/F information loaded in the corresponding network, a list of server. ID (53c) as a list of IDs of servers connected to the corresponding network, and a list of storage device box ID (53d) as a list of IDs of storage device boxes connected to the corresponding network.

The network I/F information table 54 includes information for each of a plurality of the network I/Fs, and includes an ID (54a) of the corresponding network I/F, an address (54b) allocated to the corresponding network I/F, a type (Ethernet, FC, . . . ) (54c) as a type of the corresponding network I/F such as an IF address.

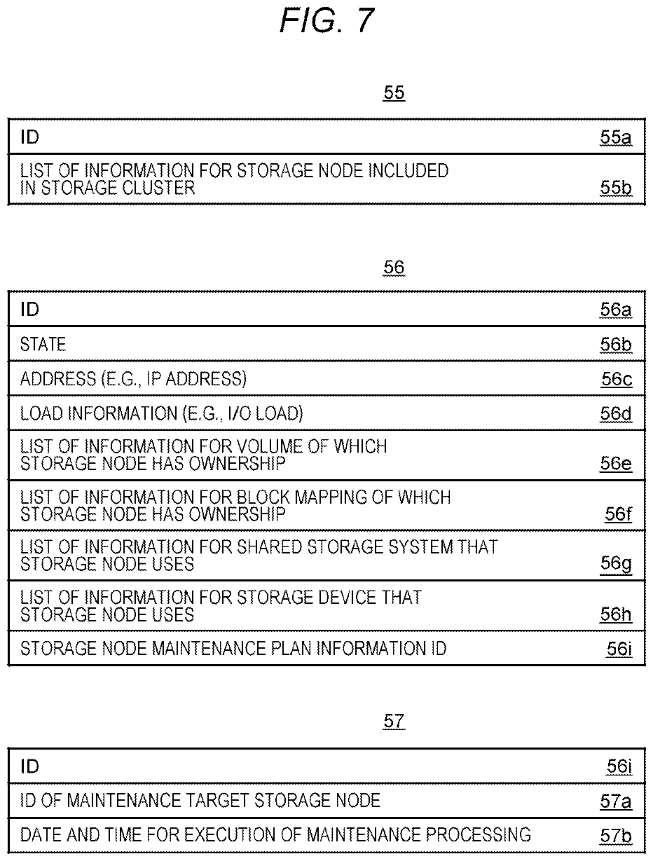

Details of metadata of the rest of the tables will be described with reference to FIG. 7. The storage cluster information table 55 includes an ID (55a) of the storage cluster, and a list of the information (51b) for each of the plurality of storage nodes 104 included in the storage cluster (55b).

The storage node information table 56 includes information for each of the plurality of storage nodes, and includes, for example, an ID (56a) of the corresponding storage node 104, a state (56b) of the corresponding storage node 104 (e.g., “maintenance in progress”, or “in operation”), an address (e.g., IP address) (56c) of the corresponding storage node 104, load information (e.g., I/O load) (56d) of the corresponding storage node 104, a list of information for the volume (56e), the volume (in the active mode) of which the corresponding storage node 104 has the ownership, a list of the block mapping information (56f) of which the corresponding storage node 104 has the ownership, a list of information for the shared storage system (56g) that the corresponding storage node 104 uses, a list of information for the storage device (56h) that the corresponding storage node 104 uses, and a maintenance plan information ID (561) of the corresponding storage node 104.

The storage node maintenance plan information table 57 includes specific information for the maintenance plan, and includes, for example, the maintenance plan information ID (56i) of the corresponding storage node as has been described above, an ID (57a) of the storage node subjected to the maintenance (hereinafter, referred to as a “maintenance target storage node”), and the maintenance plan (date and time for execution of maintenance processing) (57b). The maintenance processing corresponds to the closure of the corresponding storage node for maintenance, and recovery (restart) of the corresponding storage node from the closure for maintenance.

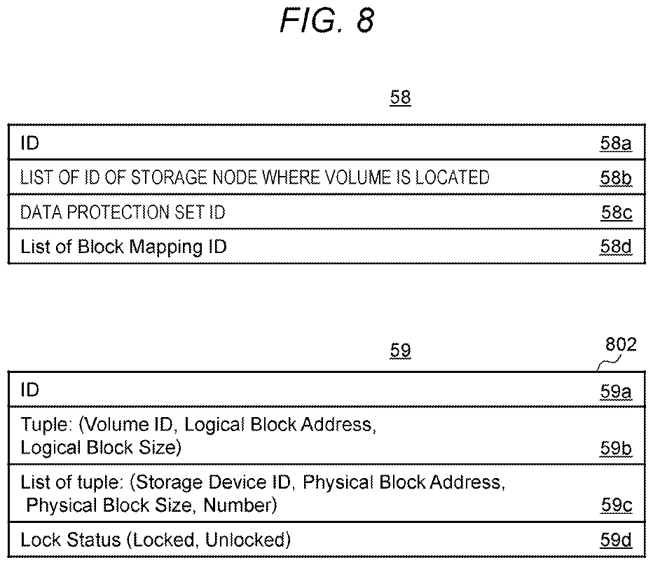

Details of metadata of the rest of the tables will further be described with reference to FIG. 8. The volume information table 58 includes information for each of the volumes (V) that has been described above, and includes an ID (58a) of the corresponding volume, a list of IDs of the storage node (58h) where the corresponding volume is located, an ID of a host server using the corresponding volume, a data protection set ID (58c) of the corresponding volume (duplication or triplication), and a list of block mapping ID (58d) in correspondence to a logical block of the corresponding volume, such as erasure coding (M data or N parity).

The block mapping information table 59 includes information for each of the block mappings, and includes, for example, an ID (59a) as a block mapping information ID, a tuple (59b) such as the volume ID, a start address of the logical block, size of the logical block, or information indicating the logical block of the volume in correspondence to the block mapping, a list of tuple (59c) including a plurality of items such as the storage device ID, a start address of a physical block, size of the physical block, and a list of data protection numbers, and a lock status (59d) of the corresponding block mapping.

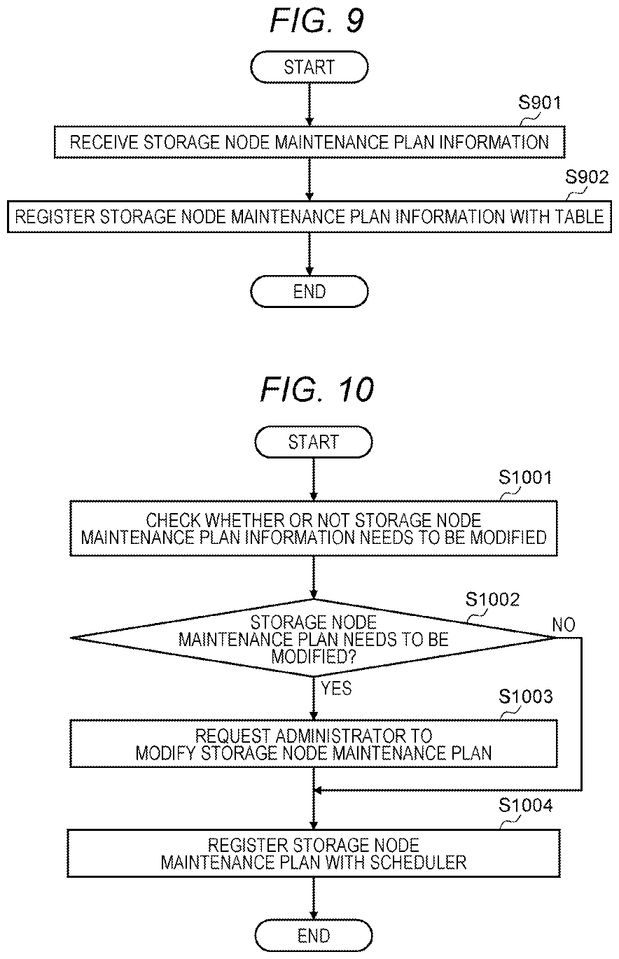

Next, the operation of the maintenance for each of the storage nodes (including the programs described above) will be described with reference to flowcharts. FIG. 9 is a flowchart of a method where the storage cluster administrator system 12 (see FIG. 1) registers storage node maintenance plan information for the storage cluster 100.

On notification from the cloud system 10, the storage cluster administrator system 12 starts the flowchart of FIG. 9. The storage cluster administrator system 12 receives the storage node maintenance plan information from the cloud system 10 (S901, and S1 in FIG. 1). The storage cluster administrator system 12 uses an API or a tool (e.g., an HTTP REST API or a dedicated command line tool) to provide the storage node maintenance plan information to each of the servers 102 (CPU 200a in FIG. 2) where the corresponding storage node of the storage cluster 100 (administered by the storage cluster administrator system 12) is loaded (S3 in FIG. 1). The CPU 200a registers the storage node maintenance plan information of the corresponding storage node with the storage node maintenance plan information table 57 of the memory 200c (S902). The CPU 200a further registers the storage node maintenance plan information ID (56i) of the corresponding storage node with the storage node information table 56.

FIG. 10 is a flowchart of the storage node maintenance plan information update processing program 71. When the flowchart of FIG. 9 ends, the CPU 200a starts the flowchart of FIG. 10. The CPU 200a checks whether or not the storage node maintenance plan information needs to be modified by referring to the storage node maintenance plan information (storage node maintenance plan information table 57), the storage cluster information (storage cluster information table 55), the storage node information (storage node information table 56), and the volume information (volume information table 58) (S1001).

Next, the CPU 200a determines whether or not the storage node maintenance plan needs to be modified (S1002); and on determination of “yes”, the CPU 200a proceeds to S1003, and on determination of “no”, the CPU 200a jumps to S1004. The storage node maintenance plan needs to be modified when, for example, the server 102 having the storage node at a high level of I/O is to be subjected to the closure for maintenance, or due to the closure for maintenance, it is difficult to maintain the level of redundancy of the storage cluster. In S1003, the CPU 200a requests the storage cluster administrator system 12 for modification of the storage node maintenance plan (S4 in FIG. 1).

Next, the storage cluster administrator system 12 causes the CPU 200a to update and register the storage node maintenance plan (that has been modified) with the storage node maintenance plan information table 57 and the storage node information table 56 (S2 in FIG. 1). The CPU 200a registers the storage node maintenance plan (that has been modified) with a scheduler of the maintenance processing, and ends the flowchart of FIG. 10. The storage cluster administrator system 12 has authority to modify and update the storage node maintenance plan, so that any maintenance plan undesired by the administrator of the storage cluster is prevented from being executed. The modification of the maintenance plan includes bringing forward or delaying the start time of the maintenance for the maintenance target storage node, change of the maintenance target storage node, a reduction in the length of time required for the maintenance, or others. Note that, the storage cluster administrator system 12 may be allowed to set suspension, cancellation, or the like of the maintenance plan.

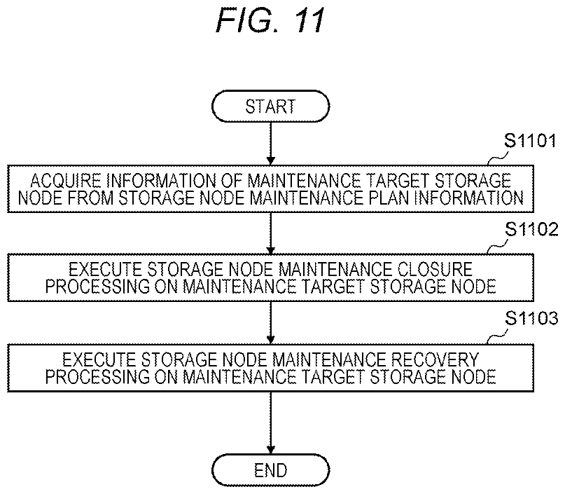

FIG. 11 is a flowchart of the storage node maintenance processing program 72. The CPU 200a starts the flowchart of FIG. 11 based on the information registered in the scheduler. The CPU 200a acquires information of the maintenance target storage node (ID of the maintenance target storage node) from the maintenance plan information (storage node maintenance plan information table 57) (S1101).

Next, the CPU 200a executes the storage node maintenance closure processing for the maintenance target storage node based on the storage node maintenance closure processing program 73 (S1102), and subsequently executes the storage node maintenance recovery processing for the maintenance target storage node based on the storage node maintenance recovery processing program 74 (S1103).

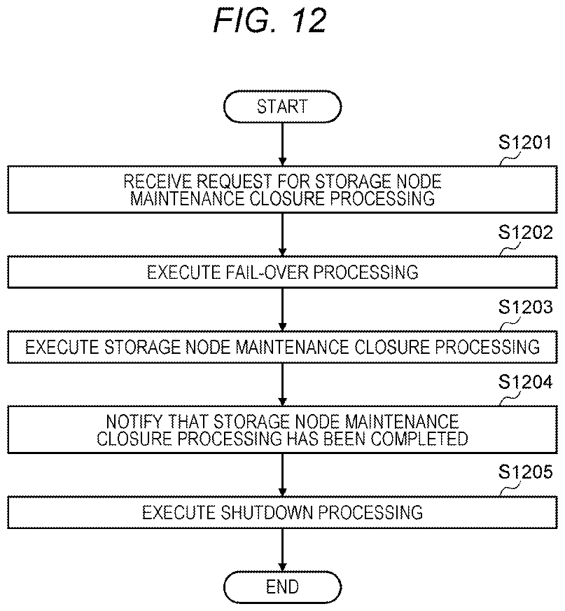

FIG. 12 is a flowchart of details of the storage node maintenance closure processing program 73. When the storage node maintenance closure processing program 73 receives from the storage node maintenance processing program 72 the request for the storage node maintenance closure in S1102 (S1201), the CPU 200a follows the schedule in the scheduler to execute the fail-over processing such that the volume, of which the maintenance (maintenance closure) target storage node has ownership, is switched from the active mode into the standby mode (S1202).

Next, the CPU 200a executes the storage node maintenance closure processing for the maintenance target storage node (S1203), and subsequently, notifies the storage node maintenance recovery processing program 74 that the storage node maintenance closure processing has completed (S1204). Then, the CPU 200a shuts down the corresponding server 102 where the maintenance (maintenance closure) target storage node is loaded (S1205).

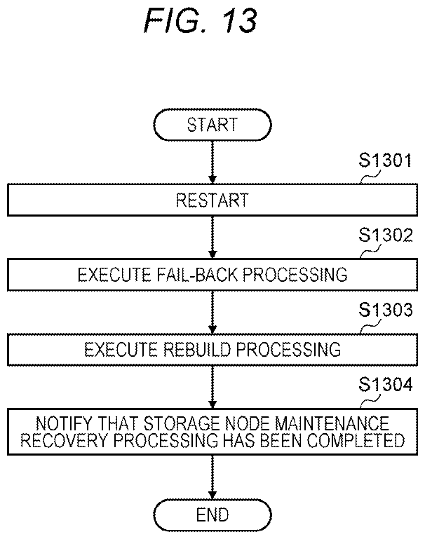

FIG. 13 is a flowchart of the storage node maintenance recovery processing program 74. On receipt of the notification from the storage node maintenance closure processing program 73 that the storage node maintenance closure processing has completed (S1204), the CPU 200a restarts the server that has been shut down in accordance with the timing determined by the scheduler (S1.301). Next, the CPU 200a switches the volume of the storage node 104, which is in the server 102 restarted, into the active mode, so as to take over the I/O processing executed by any one of the other volumes that was switched from the standby mode into the active mode in the fail-over processing (S1302).

Next, the CPU 200a rebuilds the difference data written in any one of the other volumes during the maintenance (fail-over processing) in the volume that took over the I/O processing in the fail-back processing (S1303), and subsequently notifies the storage node maintenance processing program 72 that the storage node maintenance recovery processing has completed (S1303). By following the processing in each of FIGS. 9 to 13, it is possible, regardless of the contents of the maintenance plan for the storage cluster, to achieve the maintenance that leads to the stable management of the storage cluster.

In the configuration of the foregoing embodiment, the cloud service system 10 and the storage cluster 100 have the storage cluster administrator system 12 interposed therebetween, but alternatively, without having the storage cluster administrator system 12 interposed, the cloud service system may directly apply the storage node maintenance plan information to the storage cluster. 100 and modify the storage node maintenance plan information. Further, instead of the shared storage system 108, each of the plurality of servers 102 may include the corresponding storage device.

The present invention is not limited to the foregoing embodiment, and various modifications may be included. For example, the detailed description of each of configurations in the foregoing embodiment is to be considered in all respects as merely illustrative for convenience of description, and thus is not restrictive. Additionally, a configuration of an embodiment may be partially replaced with and/or may additionally include a configuration of other embodiments. Further, any addition, removal, and replacement of other configurations may be partially made to, from, and with a configuration in each embodiment.

What is claimed is:

1. A storage system comprising:
a plurality of servers connected to one another via a network; and
a storage device,
each of the plurality of servers including a processor configured to process data input to and output from the storage device, and a memory,
wherein
the processor causes each of the plurality of servers to operate a storage node,
the processor combines a plurality of the storage nodes to set a storage cluster,
the processor performs a comparison between a maintenance plan for the storage cluster and a state of the storage cluster, so as to modify the maintenance plan based on a result of the comparison, and
the processor performs maintenance for the storage cluster in accordance with the maintenance plan modified.

2. The storage system according to claim 1, wherein the storage node is loaded in a virtual machine of each of the plurality of servers.

3. The storage system according to claim 1, wherein based on the result of the comparison between the maintenance plan for the storage cluster and the state of the storage cluster, the processor does not modify the maintenance plan and performs the maintenance.

4. The storage system according to claim 1, wherein based on the result of the comparison between the maintenance plan for the storage cluster and the state of the storage cluster, the processor modifies the maintenance plan and subsequently performs the maintenance.

5. The storage system according to claim 1, wherein the maintenance plan includes a stoppage and a subsequent restart of at least one of the plurality of storage nodes.

6. The storage system according to claim 5, wherein in accordance with the stoppage and the subsequent restart of the at least one of the plurality of storage nodes, the processor executes “fail-over”, “fail-back”, and “rebuild” between a plurality of volumes.

7. The storage system according to claim 4, wherein the processor causes an administrator system of the storage cluster to modify the maintenance plan.

8. A control method for a storage system including a plurality of servers connected to one another via a network, and a storage device, each of the plurality of servers including a processor configured to process data input to and output from the storage device, and a memory,
the control method performed by the processor comprising:
causing each of the plurality of servers to operate a storage node;
combining a plurality of the storage nodes to set a storage cluster;
performing a comparison between a maintenance plan for the storage cluster and a state of the storage cluster, so as to modify the maintenance plan based on a result of the comparison; and
performing maintenance for the storage cluster in accordance with the maintenance plan modified.
